(19) United States
(12) Patent Application Publication
(10) Pub. No.: US 2017/0072600 A1
(43) Pub. Date: Mar. 16, 2017

(54) GUN MOLD RESIN SYSTEM AND METHOD

(71) Applicant: CHRISTOPHER W. JOHNSON, JR., Longwood, FL (US)

(72) Inventor: CHRISTOPHER W. JOHNSON, JR., Longwood, FL (US)

(21) Appl. No.: 15/262,712

(22) Filed: Sep. 12, 2016

Related U.S. Application Data
(60) Provisional application No. 62/218,204, filed on Sep. 14, 2015.

(51) Int. Cl. B29C 39/10; F41A 3/66; B29C 33/10; B29C 35/02; B29C 39/26; B29C 39/36

(52) U.S. Cl. CPC B29C 39/10; B29C 39/26; B29C 39/36; B29C 33/10; B29C 35/02; F41A 3/66; B29L 2031/777

(57) ABSTRACT

A method for creating a product and a product mold kit for creating the product may include two halves of a mold casing for at least a portion of a product. The mold casing may include one or more chambers to enable escape of air bubbles. The mold casing may include at least one reservoir for applying downward pressure. The product mold kit may include one or more mold casing parts to create an internal structure of at least the portion of the product by being placed in the two halves of the mold casing. The two halves of the mold casing may be secured together. The two halves of the mold casing, when secured together, may receive resin to a fill point. The two halves of the mold casing may be separated after curing the resin. The resin may be removed from the two halves of the mold casing.

### RELATED CASES

This application claims the benefit of U.S. Provisional Application No. 62/218,204 filed on 14 Sep. 2015, the contents of which are all incorporated by reference.

### BACKGROUND

Generally, when using molds to fabricate items, air-bubbles may form and be present in the fabricated item. Air-bubbles may both reduce product strength and may cause aesthetic pits or holes in the product. Moreover, aesthetic pits and/or holes may cause the item (and resulting product) to malfunction. While some techniques may exist for eliminating or reducing such air-bubbles, such techniques may not be sufficient, easy, or feasible for all manufacturing methods, such as “do it yourself” (DIY) methods. Sometimes, one or more of the manufacturing methods may make it difficult to remove the product from the mold (e.g., de-molding) without special equipment and/or de-molding agents.

### BRIEF SUMMARY OF DISCLOSURE

In one example implementation, a method for creating a product may include but is not limited to creating two halves of a mold casing for at least a portion of a product, wherein the mold casing may include one or more chambers to enable escape of air bubbles, and wherein the mold casing may further include at least one reservoir for applying downward pressure. One or more mold casing parts may be placed in the two halves of the mold casing to create an internal structure of at least the portion of the product. The two halves of the mold casing may be secured together. The mold casing may be filled with resin to a fill point. The resin may be cured, wherein the resin may shrink as a result of curing the resin. The two halves of the mold casing may be unsecured. The two halves of the mold casing may be separated. One or more of the one or more mold casing parts may be de-molded from the mold casing. The resin may be de-molded from the mold casing.

One or more of the following example features may be included. The resin may be de-molded using hand-pressure. The resin may shrink as the result of curing the resin. The product may include a gun. At least the portion of the product may include a lower receiver of a gun. The gun may include one of an AR10 and an AR15. A brace may be placed in the two halves of the mold casing prior to filling the mold casing with resin to the fill point. The mold casing may be filled with resin to the fill point using a gravity pour technique.

In another example implementation, a product mold kit may include but is not limited to two halves of a mold casing for at least a portion of a product, wherein the mold casing may include one or more chambers to enable escape of air bubbles, and wherein the mold casing may further include at least one reservoir for applying downward pressure. The product mold kit may include one or more mold casing parts configured to create an internal structure of at least the portion of the product by being placed in the two halves of the mold casing. The two halves of the mold casing may be further configured to be secured together. The two halves of the mold casing, when secured together, may be further configured receive resin to a fill point. The two halves of the mold casing may be further configured to be separated after curing the resin. The resin, when cured, may be configured to be removed from the two halves of the mold casing.

One or more of the following example features may be included. The product mold kit may further comprise the resin, wherein the resin may be configured to shrink as a result of curing the resin. The resin may be configured to shrink as the result of curing the resin. The product may include a gun. At least the portion of the product may include a lower receiver of a gun. The gun may include one of an AR10 and an AR15. The product mold kit may further comprise one or more braces configured to be placed in the two halves of the mold casing prior to filling the mold casing with resin, wherein the one or more braces may be configured to triangulate and support to at least one of a buffer tube, one or more rear take down pins, and a hand grip bolt. At least one of the one or more braces may include at least one of a rail support brace and a threaded insert brace.

In another example implementation, a product mold kit may include but is not limited to two halves of a mold casing for at least a portion of a product, wherein the mold casing may include one or more chambers to enable escape of air bubbles, and wherein the mold casing may further include at least one reservoir for applying downward pressure. The product mold kit may include one or more mold casing parts configured to create an internal structure of at least the portion of the product by being placed in the two halves of the mold casing. The product mold kit may further include one or more braces configured to be placed in the two halves of the mold casing prior to filling the mold casing with resin, wherein the one or more braces may be configured to triangulate and support to at least one of a buffer tube, one or more rear take down pins, and a hand grip bolt. The two halves of the mold casing may be further configured to be secured together. The two halves of the mold casing, when secured together, may be further configured receive resin to a fill point. The two halves of the mold casing may be further configured to be separated after curing the resin. The resin, when cured, may be configured to be removed from the two halves of the mold casing.

One or more of the following example features may be included. The product mold kit may further comprise the resin, wherein the resin may be configured to shrink as a result of curing the resin. The resin may be configured to shrink as the result of curing the resin. The product may include a gun. At least the portion of the product may include a lower receiver of a gun. The gun may include one of an AR10 and an AR15. At least one of the one or more braces may include at least one of a rail support brace and a threaded insert brace.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a product mold kit and product according to one or more example implementations of the disclosure;

FIG. 2 is an example diagrammatic view of two example braces for use with the product mold kit of FIG. 1 according to one or more example implementations of the disclosure;

FIG. 3 is an example diagrammatic view of an example brace after being bent for use with the product mold kit of FIG. 1 according to one or more example implementations of the disclosure; and

FIG. 4 is an example diagrammatic view of a receiver with and without de-molded parts according to one or more example implementations of the disclosure.

Like reference symbols in the various drawings indicate like elements.

### DETAILED DESCRIPTION

Generally, when using molds to fabricate items, air-bubbles may form and may be present in the fabricated item. Air-bubbles may both reduce product strength and may cause aesthetic pits or holes in the product. Moreover, aesthetic pits and/or holes may cause the item (and resulting product) to malfunction. While some techniques may exist for eliminating or reducing such air-bubbles, such techniques may not be sufficient, easy, or feasible for all manufacturing methods, such as “do it yourself” (DIY) methods. Sometimes, one or more of the manufacturing methods may make it difficult to remove the product from the mold (e.g., de-molding) without special equipment and/or de-molding agents.

In some implementations, the disclosure may be designed for the DIY at home hobby gun builder and or low volume production builder. It will be appreciated that the disclosure may be used with other non-“DIY” and/or non-low volume production without departing from the scope of the disclosure. For example, the disclosure may be used and scaled up and used in Mass Production or for other types of products. As such, the use of DIY and/or low volume production should be taken as example only and not to limit the scope of the disclosure.

As will be discussed in greater detail below, example and non-limiting subjects associated with the present disclosure include solutions involving, e.g., gravity casting and/or pressure pouring a strong product, via one or more mold/resin/pour techniques that may reduce air-bubbles, enable hand de-molding a resin cast part, and home/low-volume production of a product. In some implementations, using the present disclosure, one may cast one's own lower receiver in a shorter amount of time, e.g., hours, and may do so “at home” and de-mold the product by hand without any special equipment, tools, chemical de-molding agents, or experience, such as those that may be needed and used by current large scale gun manufacturers.

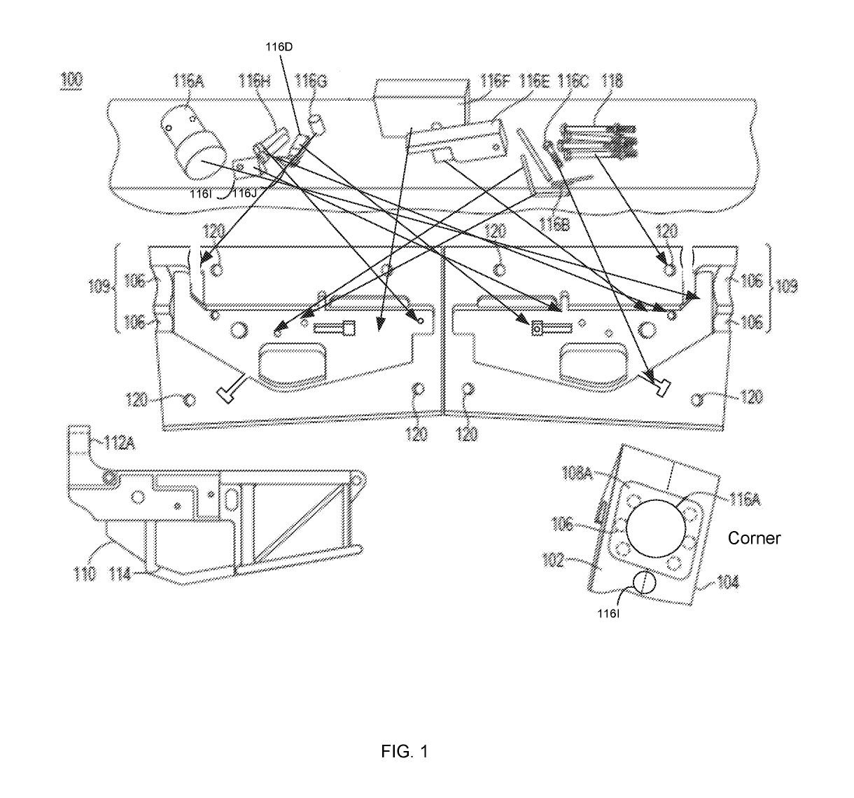

In some implementations, and referring at least to the example implementations of FIGS. 1-4, a product kit (e.g., product kit 100) and/or a method for creating a product using one or more elements of product kit 100 may include but is not limited to creating two halves of a mold casing for at least a portion of a product. For example, product kit 100 may include, e.g., a first half of a mold casing (e.g., mold casing 102) and a second half of a mold casing (e.g., mold casing 104). In some implementations, the mold and associated mold parts may be made out of any appropriate material, including but not limited to metal, polycarbonate, plastics, wood and their many variations/combinations. In some implementations, portions of the mold casing (e.g., mold casing 102 and/or mold casing 104) may be individually machined, or mass produced using, e.g., a mold template.

In some implementations, the mold casing (e.g., via mold casing 102 and/or mold casing 104) may include one or more chambers to enable escape of air bubbles. For example, mold casing 102 and/or mold casing 104 may include one or more air chambers (e.g., air chambers 106) that may be strategically located in the mold design. Typically, the air chambers may be located at the highest point of the mold to allow the air to gather. However, in some implementations, the air chambers may be located in other position(s).

In some implementations, mold casing (e.g., via mold casing 102 and/or mold casing 104) may include at least one reservoir for applying downward pressure. In some implementations, downward pressure may be applied to the mold casing via air pressure introduced to the mold casing via a pressure chamber. For example, mold casing 102 and/or mold casing 104 may include at least one reservoir and vent system (e.g., reservoir 108A and venting 109) that may be strategically located in the mold design. The reservoir and vent system may be located at the highest point, near the fill point of the mold. In some implementations, the reservoir may be located in another position. The reservoir and vent system, combined with downward pressure, may help to strengthen the resin. For instance, in some implementations, the corresponding resin strength may be, e.g., doubled after applying, e.g., 60 psi of air pressure during the cure time to a mold with this reservoir and vent system. This strength increase may be due to air pressure compressing the resin in the reservoir and vent system downward into the mold. The resin compression may reduce the size of air-bubbles and may increase the product strength.

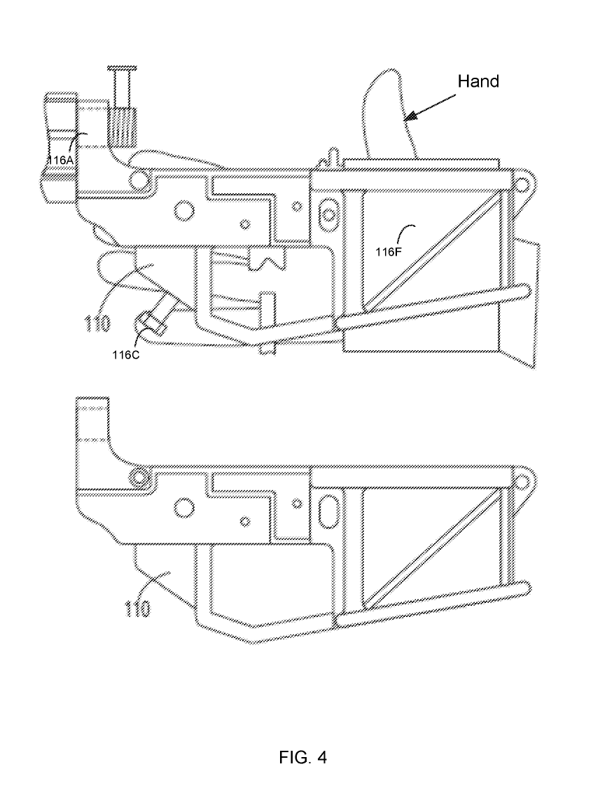

In some implementations, the product may include a gun. In some implementations, at least the portion of the product may include a lower receiver of a gun. For instance, and referring at least to FIGS. 1 and 4, an example of a lower receiver (e.g., lower receiver 110) that may be created using the example mold casing 102/104 is shown. In some implementations, lower receiver 110 may be considered part of the physical gun. As shown in FIGS. 1 and 4, a finished “gravity cast” lower receiver 110 according to one or more example implementations is shown. The two large white blocks (e.g., mold casing 102 and mold casing 104) with the cut out may be the primary molds cut out of polycarbonate (or other material).

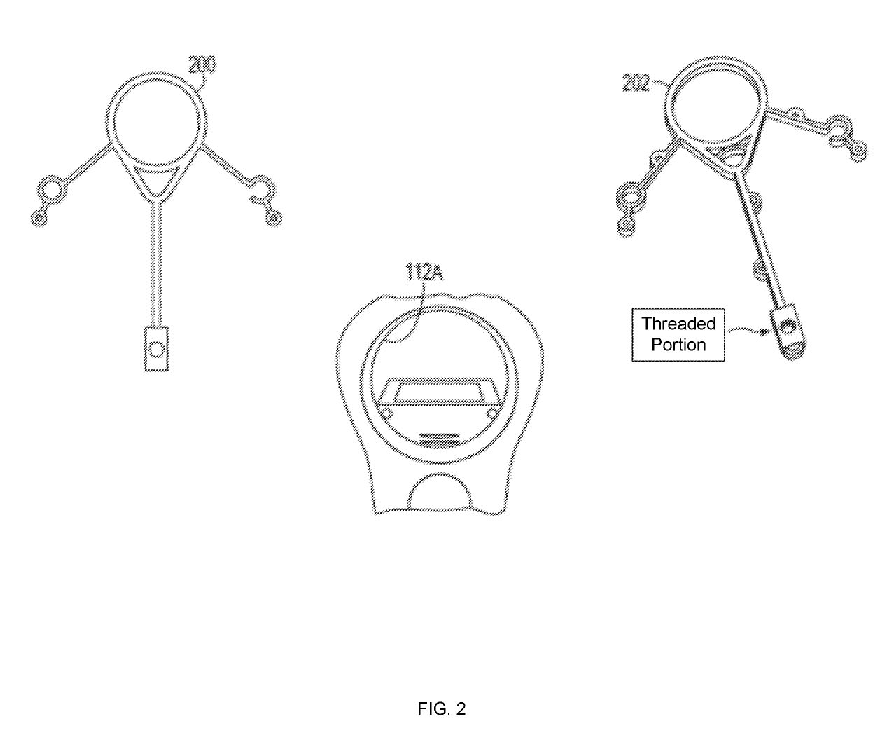

In some implementations, the product may include other gun types, and at least the portion of the product may include their individual gun parts, such as magazines. In certain implementations, the gun may include one of an AR10 and an AR15 or another type of rifle or handgun. In some implementations, lower receiver 110 may differ from the “original” (i.e., “Military Specification AR15”) design specifications of, e.g., the AR15 lower receiver. For instance, in some implementations, the buffer tube area (e.g., buffer tube area 112A shown also in FIG. 2) may be made larger and wider (e.g., via mold casing 102 and/or mold casing 104) for additional strength. In some implementations, the original “Military Specification AR15” values may be increased by, e.g., 30% and may also include a contour to improve strength. As another example, in some implementations, a larger and/or wider trigger guard (e.g., trigger guard 114) may be included in the mold design that enables the receiver 110 to work with a gloved finger. The original “Military Specification AR15” was designed to have a removable trigger guard. In some implementations, the mold design may have integrated the trigger guard.

As noted above, air-bubbles may both reduce product strength and may cause aesthetic pits or holes in the product, which may cause the product to malfunction. However, the example mold design may be able to significantly reduce (or eliminate) casting air-bubbles that may reduce product strength and/or holes/pits via any combination of, e.g., 1) adding small chambers (e.g., chambers 106) in the mold design that may allow the air-bubbles to escape, 2) utilization of a multi-part plastic resin that may be designed to reduce air-bubbles, and/or 3) a mold design and associated mold components that may have been adjusted via a process to reduces air-bubbles as the resin is poured into the mold. In some implementations, the air-bubbles that may remain may not affect the strength of the product or cause aesthetic holes and/or pits in the product.

In some implementations, product kit 100 may include, e.g., one or more associated mold parts and/or a resin (e.g., a multi-part plastic resin) that may allow one to “gravity cast” lower receiver 110 or most any gun part without using pressure or vacuum. However, in some implementations, the venting system may allow the unit to be either “gravity poured” or “pressure poured” (e.g., pour the resin and then place the entire unit in a pressure chamber).

In some implementations, one or more mold casing parts may be placed in the two halves of the mold casing to create an internal structure of at least the portion of the product. For example, the one or more mold parts may be inserted into the mold casing to create the internal structure of the lower receiver. In some implementations, the one or more mold casing parts (e.g., mold casing parts 116A-116J) may include, e.g., the smaller white parts and pins. In some implementations, the mold casing parts may create the voids and the internal structure of the part. Each part may have a specific place in the mold. Part 116A (with a hole to receive a pin) may create the buffer tube void and buffer tube threads. Part 116B (metal pins) may create voids in the mold for the detents and the trigger pins. Part 116C (bolt) may create the threads that allow the handgrip to be bolted to the cast lower. Part 116D may create the void for the magazine release button. Part 116E may create the void for the trigger group assembly. Part 116F may create the void for the magazine well. The fill plug for the mold may be part of 116G Parts 116H (one with a thicker base installed inside the mold and one with a thinner base installed outside the mold) may be the two pins that create the voids for the front and rear takedown pins. Part 116I may create the void for the front take down mount. Parts 116J (with the hole to receive a pin) may create the void for the bolt catch assembly. The locations of where the mold casting parts are inserted into the mold are shown by arrows in FIG. 1.

In some implementations, the one or more mold parts may have been designed to reduce air bubbles and work specifically with the mold design of product kit 100. In some implementations, the molded part may not be air-bubble free; however, in some implementations, the air bubbles that remain may not affect the product functionality after the product has been heat cycled to, e.g., 150° F. to cure the part. In some implementations, variations/modifications to the mold design may require appropriate variations/modifications to the designs of the mold parts. In some implementations, the mold, mold parts and the plastic resin in any combination with the plastic resin pour technique may be beneficial for successful casting of the example product (e.g., via the reduction of air-bubbles when using pour techniques, such as a “gravity pour” technique).

In some implementations, and continuing with the above example, the two halves of the mold casing (e.g., mold casing 102 and/or mold casing 104) may be secured together. For example, the mold casings may be bolted together with one or more bolts (or other means). In the example, a screw/bolt design may be incorporated into the mold design. For instance, after the one or more mold parts are inserted into the mold casing to create the internal structure of the lower receiver, screw/bolt 118 may be placed through one or more holes (e.g., holes 120) in the mold casing. In the example, mold casing 102 may be placed parallel mold casing 104 such that holes 120 are aligned to receive screw/bolt 118. The mold may also be secured together via, e.g., external clamps, straps or any other type of device designed to hold two parts together. The halves may be sealed with, e.g., silicone sealant or it may be machined for an o-ring seal.

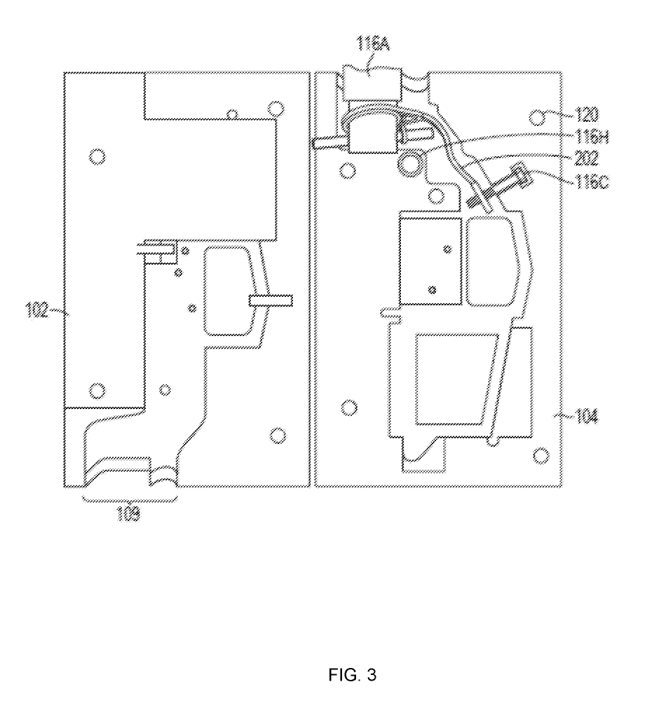

Unlike a known and simple round insert, the present disclosure may (additionally or in place of the round insert) make use of a brace, which may be, e.g., laser cut or otherwise manufactured. For instance, in some implementations, a brace may be placed in the two halves of the mold casing prior to filling the mold casing with resin to the fill point, wherein the one or more braces may be configured to triangulate and support to at least one of a buffer tube, one or more rear take down pins, and a hand grip bolt. Referring at least to FIGS. 2 and 3, two example braces (e.g., brace 200 and brace 202) are shown. In the example, a brace (e.g., brace 202) may be placed between mold casing 102 and mold casing 104 prior to filling the mold casing with resin. The brace may be fabricated out of any type of strong and appropriate material, such as, e.g., stainless steel, fiberglass, plastic, carbon fiber, etc. The brace may be bent to follow the contour of the mold and then inserted into the mold, as shown in example FIG. 3. After insertion into the mold, the brace may be encapsulated into place via the resin. The big hoop on the brace may be inserted into the buffer plug (Part 116A) and the smaller brace arms may slip through the rear take down pin (Part 116H) and the threaded part of the brace threads onto (Part 116C). The brace installation may triangulate and spread out the load that is transferred from buffer tube assembly into the lower receiver each time the weapon fires. In some implementations, when used with the present disclosure, brace 202 may allow one to fire a load/round (e.g., a high-powered load/round) without much (if any) risk of plastic/polymer failure.

In some implementations, to aid final product strength and reliability, modifications to the original AR10/AR15 design (e.g., mold casing 102 and/or mold casing 104) may include, e.g., additional structure and bracing added to the top rail (e.g., via brace 202), magazine-well (bottom, front, back), center receiver bracing on the sides and thicker bracing at some or all pin locations (e.g., via brace 202).

In some implementations, and referring at least to FIGS. 2 and 3, brace 202 may be bent and inserted into the mold. The big hoop on the brace may be inserted into the buffer plug (Part 116A) and the smaller brace arms may slip through the rear take down pin (Part 116H) and the threaded part of the brace threads onto (Part 116C). The brace installation may triangulate and spread out the load that is transferred from buffer tube assembly into the lower receiver each time the weapon fires. In some implementations, at least one of the one or more braces may include at least one of a rail support brace and a threaded insert brace. The threaded insert could be made out of, e.g., metal, fiberglass, carbon-fiber or plastic. This threaded insert may screw onto the buffer plug (Part 116A) and it may be left in place in the mold to reinforce the buffer tube threads.

In some implementations, the mold casing may be filled with resin to a fill point. For example, in some implementations, after the appropriate mold casing parts (and brace 202 in this example) are placed in the two halves of the mold casing, the two halves of the mold casing (e.g., mold casing 102 and/or mold casing 104) may be secured together, such that the mold casing may then be filled with resin, thereby encapsulating brace 202 and the associated mold parts into the final product. The resin may be poured into the mold via a fill hole (typically in the highest part of the mold) and air may vent out of the venting system. The resin may be mixed using appropriate instructions and then poured (filled) into the mold. In some implementations, the mold casing may include a particular fill point, which may indicate a maximum (or minimum) level up to which to fill the mold with the resin. The mold may be filled to the correct level once resin is overflowing slightly from the fill hole and from the venting system. Any type of polymer resin that is strong enough may be used. In the example, and as noted above, product kit 100 may reduce air-bubbles by, e.g., utilizing the chambers in the mold combined with a specific resin fill point and/or specific air vent points.

In some implementations, the mold casing may be filled with resin to the fill point using a gravity pour technique. In some implementations, the gravity pour technique may include, e.g., (1) slowly filling the mold until resin overflows out of the fill plug and venting system, and (2) moving around the mold to allow the air bubbles to find their way to the fill plug and venting system. In some implementations, during the pour, the mold may be moved using specific movements to reduce air bubbles. For instance, the mold may be rocked back and forth and/or side to side. In some implementations, the mold may be set on a vibration table to help the air bubbles up to the vents and fill plug. In some implementations, other resin filling techniques may be used without departing from the scope of the disclosure. For instance, pressure pouring techniques and vacuum pouring techniques may also be used.

In some implementations, which may also include the pressure pour technique, the same vent system may also be used for a gravity pour. When performing a pressure pour, one may slowly pour the resin into the mold and completely fill the resin reservoir and insert the plug. The mold may then be inserted into a pressure chamber and air pressure may be added to the chamber during the resin cure time. In some implementations, a vacuum chamber may be utilized during the pour. In some implementations, the resin may be mixed and then the bubbles may be vacuumed out prior to gravity pouring. In some implementations, the entire mold may be inserted into a vacuum chamber during the resin cure time. As such, the use of a gravity pouring technique should be taken as example only and not to limit the scope of the disclosure.

In some implementations, using an example plastic resin, the disclosed gravity cast lower receiver may function without failure up to a product temperature of, e.g., 165° F. However, based upon the requirements of the product, other resins that may allow higher or lower ceiling temperatures may be used without departing from the scope of the disclosure depending on, e.g., environmental usage, storage and/or shipping. While other resins may be used, some plastic resins may fail or “flex” between a temperature of, e.g., 110° F. and 130° F. Failures may be classified as either catastrophic (e.g., part breaks in two or more places) or minor (e.g., buffer tube/stock warps, etc.).

In some implementations, the resin may be cured, wherein the resin may shrink as a result of curing the resin. Typically, when a product is cast with (e.g., plastic) resin, the resin may bond to the mold, and it may be difficult to de-mold without using de-mold agent, air pressure or other tools. In some implementations, the selected resin used for the mold may enable a user to not have to rely on de-molding agent, although a de-molding agent may be helpful. For example, in some implementations, the resin may shrink, e.g., between 0.008 in./in. to 0.003 in./in as the result of curing the resin. In some implementations, the example mold and associated mold parts of the disclosure may have been specifically designed for “hand de-molding” without using a de-molding agent, any special tool, or air pressure. For example, in some implementations, the mold itself may have been built out of a polycarbonate plastic and the plastic resin may have been designed with a specific cure shrinkage of, e.g., 0.006 in./in. to allow de-molding to occur without the use of de-mold agent, air pressure, or tools. For instance, in some implementations, when the resin cures, it may shrink a specific amount, thereby making it easier to use hand pressure to help release the final cured product from the mold. An example acceptable range of shrinkage may be between, e.g., between 0.008 in./in. to 0.003 in./in. In some implementations, the mold and associated mold parts may be made out of a different material, but it may then be more difficult to “hand de-mold”.

In some implementations, the two halves of the mold casing may be unsecured, and the two halves of the mold casing may be separated. For example, the above-noted screw/bolt 118 may be removed from holes 120 after an initial curing of the resin. In some implementations, one or more of the one or more mold casing parts may be de-molded from the mold casing, the resin may be de-molded from the mold casing, and the resin may be de-molded using hand-pressure. For instance, after the resin first cures (e.g., overnight) the mold may be unbolted, separated by hand, and the part (e.g., due to the above-noted shrinkage) may be removed from the mold casing using, e.g., hand pressure (or the like). Similarly, the small parts may be removed from the part using hand pressure (or the like). In some implementations, the final part (e.g., lower receiver 110) may then be cured again in an oven (e.g., a home oven) per the appropriate instructions.

In some implementations, and referring at least to FIG. 4, an example of a lower receiver (e.g., lower receiver 110) right after being de-molded by hand is shown. In some implementations, as shown in the top portion of FIG. 4, one or more of the mold casing parts may still remain in lower receiver 110, and may still need to be removed, e.g., using hand pressure, resulting in lower receiver 110 shown in the bottom portion of FIG. 4. In some implementations, the one or more of the mold casing parts may be removed from lower receiver 110 (e.g., using hand pressure) at the same time as the entire piece of lower receiver 110, as the one or more mold casing parts may be sufficiently attached to the mold casings as a result of curing the resin.

It will be appreciated that product kit 100 may be provided in any combination with the mold casings, mold casing parts, brace, and resin. For instance, product kit 100 may be provided to an end user with the mold casings, mold casing parts, and brace 202, but the resin may be obtained separately. As another example, product kit 100 may be provided with the mold casings, mold casing parts, and resin, but not include brace 202. For instance, using a pressure pouring technique may make the resulting lower receiver similarly as strong as using a gravity pour technique with a brace. Therefore, although not required, using the brace and the pressure pouring technique may make for a stronger lower receiver. As such, the example disclosure of product kit 100 including mold casings, mold casing parts, brace, and resin all in a single kit should be taken as example only and not to limit the scope of the disclosure.

While one or more implementations involve guns as a product, it will be appreciated that other products (and associated product parts) may be created using any combination of the techniques described herein. As such, the use of guns and/or gun parts as products should be taken as example only and not to otherwise limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method for creating a product comprising:
creating two halves of a mold casing for at least a portion of a product, wherein the mold casing includes one or more chambers to enable escape of air bubbles, and wherein the mold casing further includes at least one reservoir for applying downward pressure;
placing in the two halves of the mold casing one or more mold casing parts to create an internal structure of at least the portion of the product;
securing together the two halves of the mold casing;
filling the mold casing with resin to a fill point;
curing the resin, wherein the resin shrinks as a result of curing the resin;
unsecuring the two halves of the mold casing;
separating the two halves of the mold casing;
de-molding one or more of the one or more mold casing parts from the mold casing; and
de-molding the resin from the mold casing.

2. The method of claim 1 wherein the resin is de-molded using hand-pressure.

3. The method of claim 1 wherein the resin shrinks as the result of curing the resin.

4. The method of claim 1 wherein the product includes a gun.

5. The method of claim 1 wherein at least the portion of the product includes a lower receiver of a gun.

6. The method of claim 5 wherein the gun includes one of an AR10 and an AR15.

7. The method of claim 1 further comprising placing a brace in the two halves of the mold casing prior to filling the mold casing with resin to the fill point.

8. The method of claim 1 further comprising filling the mold casing with resin to the fill point using a gravity pour technique.

9. A product mold kit comprising:
two halves of a mold casing for at least a portion of a product, wherein the mold casing includes one or more chambers to enable escape of air bubbles, and wherein the mold casing further includes at least one reservoir for applying downward pressure;
one or more mold casing parts configured to create an internal structure of at least the portion of the product by being placed in the two halves of the mold casing;
wherein the two halves of the mold casing are further configured to be secured together;
wherein the two halves of the mold casing, when secured together, are further configured receive resin to a fill point;
wherein the two halves of the mold casing are further configured to be separated after curing the resin;
wherein the resin, when cured, is configured to be removed from the two halves of the mold casing.

10. The product mold kit of claim 9 further comprising the resin, wherein the resin is configured to shrink as a result of curing the resin.

11. The product mold kit of claim 9 wherein the resin is configured to shrink 0.001 inches as the result of curing the resin.

12. The product mold kit of claim 9 wherein the product includes a gun.

13. The product mold kit of claim 9 wherein at least the portion of the product includes a lower receiver of a gun.

14. The product mold kit of claim 13 wherein the gun includes one of an AR10 and an AR15.

15. The product mold kit of claim 9 further comprising one or more braces configured to be placed in the two halves of the mold casing prior to filling the mold casing with resin, wherein the one or more braces may be configured to triangulate and support to at least one of a buffer tube, one or more rear take down pins, and a hand grip bolt.

16. The product mold kit of claim 15 wherein at least one of the one or more braces may include at least one of a rail support brace and a threaded insert brace.

17. A product mold kit comprising:
two halves of a mold casing for at least a portion of a product, wherein the mold casing includes one or more chambers to enable escape of air bubbles, and wherein the mold casing further includes at least one reservoir for applying downward pressure;
one or more mold casing parts configured to create an internal structure of at least the portion of the product by being placed in the two halves of the mold casing;
one or more braces configured to be placed in the two halves of the mold casing, wherein the one or more braces may be configured to triangulate and support to at least one of a buffer tube, one or more rear take down pins, and a hand grip bolt;
wherein the two halves of the mold casing are further configured to be secured together;
wherein the two halves of the mold casing, when secured together, are further configured receive resin to a fill point;
wherein the two halves of the mold casing are further configured to be separated after curing the resin;
wherein the resin, when cured, is configured to be removed from the two halves of the mold casing.

18. The product mold kit of claim 17 further comprising the resin, wherein the resin is configured to shrink as a result of curing the resin.

19. The product mold kit of claim 17 wherein the resin is configured to shrink 0.001 inches as the result of curing the resin.

20. The product mold kit of claim 17 wherein at least the portion of the product includes a lower receiver of a gun.

21. The product mold kit of claim 20 wherein the gun includes one of an AR10 and an AR15.

22. The product mold kit of claim 17 wherein at least one of the one or more braces may include at least one of a rail support brace and a threaded insert brace.
